(19) United States
(12) Patent Application Publication
(10) Pub. No.: US 2013/0066893 A1
(43) Pub. Date: Mar. 14, 2013

(54) PROTECTION OF DATA PRIVACY IN AN ENTERPRISE SYSTEM

(71) Applicant: HANS-CHRISTIAN HUMPRECHT, (US)

(72) Inventor: HANS-CHRISTIAN HUMPRECHT, (US)

(21) Appl. No.: 13/231,267

(22) Filed: Sep. 13, 2011

(51) Int. Cl. G06F 21/24; G06F 17/30

(52) U.S. Cl. 707/757; 707/E17.009

(57) ABSTRACT

Various embodiments of systems and methods for protection of data privacy in an enterprise system are described herein. A request to access data stored in an electronic database is received. The data comprises restricted and unrestricted entities. A restricted entity is replaced with one or more masked attributes that protect privacy of the restricted entity. A mask layout comprising the one or more masked attributes is defined for the restricted entity. The one or more masked attributes are then provided to a user in response to the request.

### FIELD

The field relates generally to data management systems. More particularly, the field relates to protection of data privacy.

### BACKGROUND

Enterprises typically maintain data of several entities such as employees, customers, and suppliers. This data is stored and can be used for several purposes such as for transactions, data collections, analytics and reporting. Some of the stored information can be sensitive or private and required to have access restrictions to comply with statutory data privacy regulations. The relationship between an entity and an enterprise may define the way privacy should be handled. For example, data of an ex-employee needs to be handled differently compared to data of existing employees. Data of an ex-employee may need to be deleted or restricted for limited access. Similarly, data of a barred supplier or a past customer may need to be handled differently compared to existing suppliers or customers. However, sensitive data may not be segregated and is typically stored along with other data. Applications that access stored data consider sensitive and non-sensitive data alike and may disclose sensitive data, leading to privacy issues.

It would therefore be desirable to protect sensitive data to comply with data privacy policies and regulations.

### SUMMARY

Various embodiments of systems and methods for protection of data privacy in an enterprise system are described herein. A request to access data stored in an electronic database is received by a computer. The data comprises restricted and unrestricted entities. A restricted entity is replaced with one or more masked attributes that protect privacy of the restricted entity. A mask layout comprising the one or more masked attributes is defined for the restricted entity by a system administrator. The one or more masked attributes are then provided to a user in response to the request.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram of an enterprise system environment, according to one embodiment.

FIG. 2 is a block diagram of a method for protecting data privacy in an enterprise system, according to one embodiment.

FIG. 3 is a block diagram of a user interface displaying a result of query to a database, according to one embodiment.

FIG. 4 is a block diagram of a process for defining a mask layout, according to one embodiment.

FIG. 5 is a block diagram of a scenario where data privacy is protected in an enterprise system environment, according to one embodiment.

FIG. 6 is a block diagram of an exemplary computer system according to one embodiment.

### DETAILED DESCRIPTION

Embodiments of techniques for protection of data privacy in an enterprise system are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

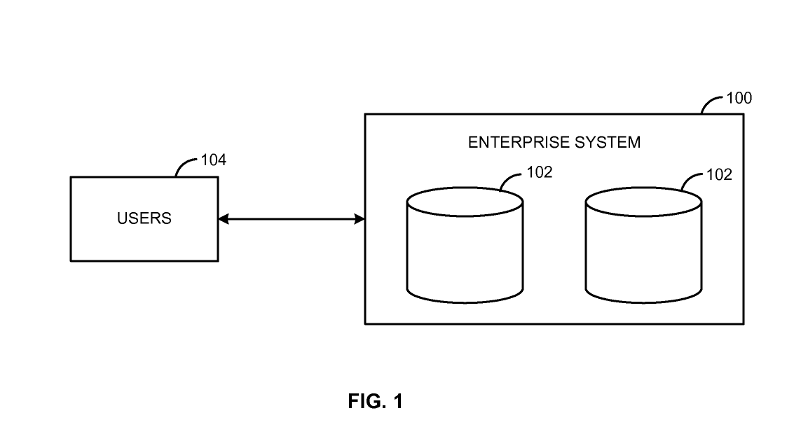

Referring to FIG. 1, an enterprise system 100 is commonly used for managing various functions of a business. Almost all business-related data such as financial data and data of suppliers, customers, and employees is stored in an electronic database 102 of the enterprise system 100. The data can be stored in more than one electronic database 102. In one embodiment, the enterprise system 100 is an Enterprise Resource Planning (ERP) system. Several users 104 access the enterprise system 100. The users 104 can be categorized depending on their role and responsibility, which can define the way the data can be accessed or what data can be accessed. For example, a user from a particular function of a business such as sales division has in-depth access to sales data but may not have ready access to data of other business functions. Similarly, a user from human resources division has access to employee data but may not have ready access to sales data. The users 104 also include a data or system administrator who plays a key role in managing and controlling access to data.

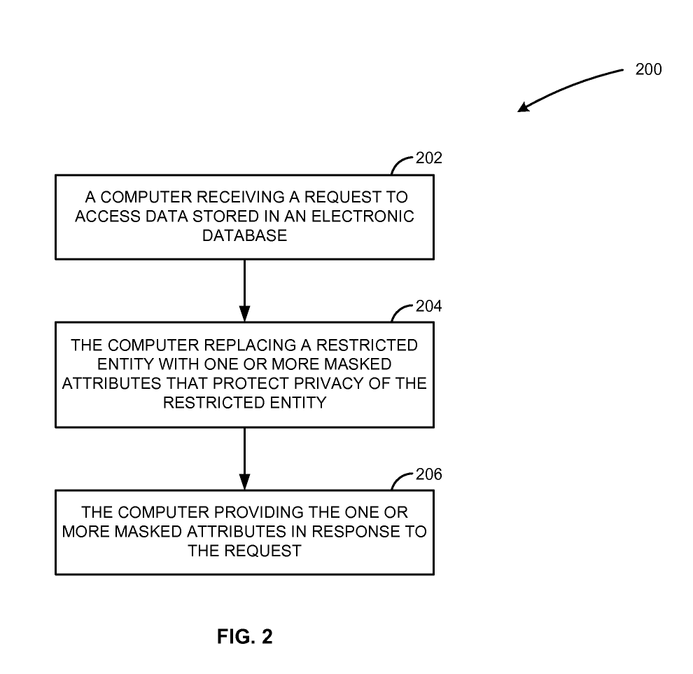

FIG. 2 illustrates an embodiment of a method for protecting data privacy in an enterprise system. Various activities such as reporting, business analytics, business transactions, etc, require access to stored data. Typically, users access an enterprise application and select various options on a user interface to perform such activities. In response to user selections, at 202, a computer receives a request to access data stored in an electronic database. The request indicates what data is required and should be accessed based on the user selections.

The stored data, however, includes both restricted entities and unrestricted entities. An enterprise has relationship with several entities such as an employee, an individual, a customer, and a supplier. The relationship between the enterprise and the entity and a data privacy policy define the way data of the entity should be or will be handled. In one embodiment, the data privacy policy is a statutory policy for protecting data privacy. In another embodiment, the data privacy policy is a custom data privacy policy of the enterprise that is agreed by the entity and complies with the statutory data privacy policy.

Based on the data privacy policy, data of some entities can be sensitive and may not be accessed by all users. Access or viewing restrictions should be in place to protect privacy. Data of entities that should have access restrictions are called as restricted entities. For example, data of an ex-employee needs to have restrictions to prevent inadvertent viewing by a user of an enterprise application. A data privacy policy may require that the data of an ex-employee should be either deleted after formalities or restricted for limited access. Whereas data of existing employees can be viewed by any authorized user, e.g., a human resource professional. Therefore, data of the ex-employee is a restricted entity and data of an existing employee is an unrestricted entity. Similarly, data of a supplier or a customer with whom the enterprise no longer maintains a relationship may need to be protected as per data privacy clauses in an agreement. Such data which needed to be protected is categorized as restricted entities. Data of current suppliers or customers fall into the category of unrestricted entities and can be accessed by any authorized user.

At 204, if the request requires accessing restricted entities, the restricted entities are replaced with one or more masked attributes. These masked attributes are such that they protect the privacy of the restricted entity. For example, a masked attribute can be a word such as “customer blocked” or “blocked user.” A masked attribute can be any combination of letters that indicates that the entity is restricted and its information cannot be viewed. To replace a restricted entity an attribute, a system admin should define a mask layout for the restricted entity as soon as an entity is classified as a restricted entity as per a data privacy policy. The mask layout includes one or more masked attributes that conceal the identity or other information of the restricted entity. These masked attributes are assigned to attributes of a restricted entity. For example, the attributes of an ex-employee includes name and other dependant information such as contact information, date of birth, tenure, etc. The system admin defines masked attributes for the attributes of the ex-employee. In one embodiment, a single masked attribute such as “blocked user” can be defined for all the attributes or for the restricted entity as a whole. So whenever there is a request to access data of the ex-employee (e.g., one or more attributes of the ex-employee), the data of the ex-employee is replaced with the masked attribute “blocked user.”

As an example, consider that a utility company maintains data of its customers using an enterprise system. Information related to customers can be stored in an electronic database in a plurality of tables. Example of some tables “ORD” and “CUST” are presented below:

ORD

| ID | NAME | ARTICLE |
|---|---|---|
| 1 | Name 1 | 4711 |
| 2 | Name 2 | 4711 |
| 3 | Name 3 | 4712 |
| 4 | Name 4 | 4772 |
| . | . | . |
| 17 | Name 17 | 4713 |
| . | . | . |
| n | Name n | 4788 |

CUST

| ID | NAME | ADDRESS |
|---|---|---|
| 1 | Name 1 | Street . . . |
| 2 | Name 2 | Street . . . |
| 3 | Name 3 | Street . . . |
| 4 | Name 4 | Street . . . |
| . | . | . |
| 17 | Customer 17 | Street . . . |
| . | . | . |
| n | Customer n | Street . . . |

The ORD table is a table to store product order details of the customers. The ORD table includes a customer ID column, a customer name column, and an article column for product codes or identifiers. The CUST table stores details of all customers. The details include attributes of customers such as name and address. Consider that the utility company is not doing business with some customers 1, 2, and 17. The private information of customers 1, 2, and 17 may need to be restricted or deleted sometime in the future. A table “CUST_B,” as shown below, can be used to define a mask layout.

CUST_B

| ID | NAME | NAME_B | STATUS |
|---|---|---|---|
| 1 | Name 1 | Customer blocked | 0 |
| 2 | Name 2 | Customer blocked | 1 |
| 17 | Name 17 | Customer blocked | 1 |

The CUST_B table stores details of customers who need to be restricted. The CUST_B table includes a NAME_B column which stores masked attributes with respect to the attributes (i.e. names) of the customer. The mask layout also includes statuses for replacing the restricted entity with a masked attribute. The CUST_B table includes a status column for defining the statuses for the restricted entities. As an example, a status ‘1’ for a customer indicates that the customer is in a blocking period, meaning that the customer data or attribute (e.g., name) should be replaced with the masked attribute “Customer blocked”. A status ‘0’ for a customer indicates that the blocking period for that customer has not yet started. A system administrator or a person responsible for data protection defines these statuses and also adds or deletes customers from CUST_B table based on a data privacy policy.

With a defined masked layout in place, after a request is received, the restricted entities which are in the CUST_B table and have status ‘1’ are replaced with corresponding masked attributes. The masked attributes along with any unrestricted entities are provided to the user at 206. In one embodiment, a filter is used to replace the restricted entities. The following statement in Structured Query Language (SQL) syntax shows an example of a filter that replaces a restricted entity.

SELECT

Ord.ID,Article,Adress

CASE

WHEN Status = 1 THEN Name_b ELSE Name

END

AS Masked_Name

FROM

Ord INNER JOIN Cust

ON

Ord.ID = Cust.ID LEFT OUTER JOIN Cust_b

ON

Ord.Name = Cust_b.Name

The filter is an SQL query for presenting data while replacing the restricted entities. The SQL query is generated in response to a user operation. The SELECT statement selects data from tables that are stored in the database. The result from the select statement is stored in a result-set. The SQL CASE statement is used to manipulate the presentation of data without updating or changing the data in a table and the value of the field “Masked Name” depends on the CASE statement. The SQL JOIN clauses enable to select data from a plurality of tables. When the status column for a customer in CUST_B table is ‘1,’ the name of that customer is replaced with a masked attribute that is in the CUST_B table.

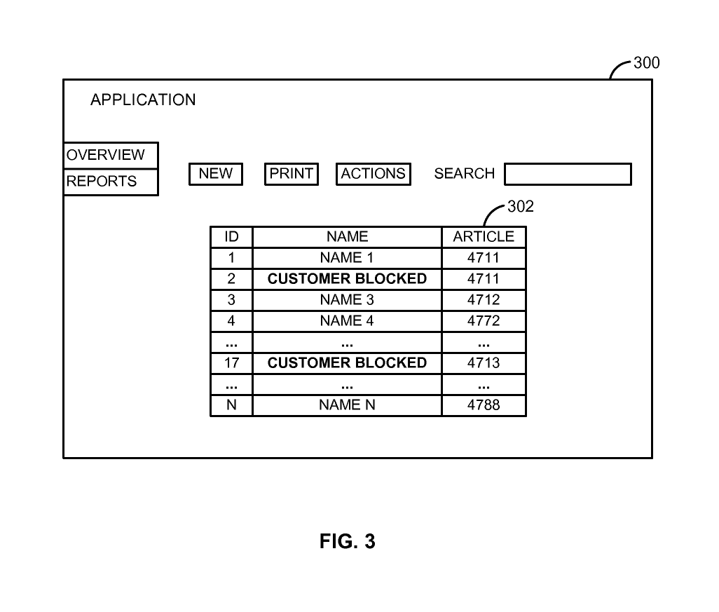

Referring to FIG. 3, the result list of the above SQL query is presented on a user interface 300 of an enterprise application. The result list 302 includes unrestricted entities such as names of customers 1, 3 and 4 and masked attributes (customer blocked) of the restricted entities, i.e. customer 2 and 17. Since the status of customer ‘1’ is set to ‘0,’ in one embodiment, it is not fully qualified as a restricted entity for data privacy protection and therefore displayed without any masked attributes.

The above-described approach can be applied to several scenarios. For example, the approach can be applied to employees of an organization. A table such as Employee_B can be created for restricted entities to define a masked layout. The restricted entities are ex-employees who left the organization or employees who are about to leave the organization. Masked attributes such as “Blocked User” or “Data restricted” can be assigned to the restricted entities. Similar approach can be used for suppliers or any other entity whose data is stored in the database of an enterprise system.

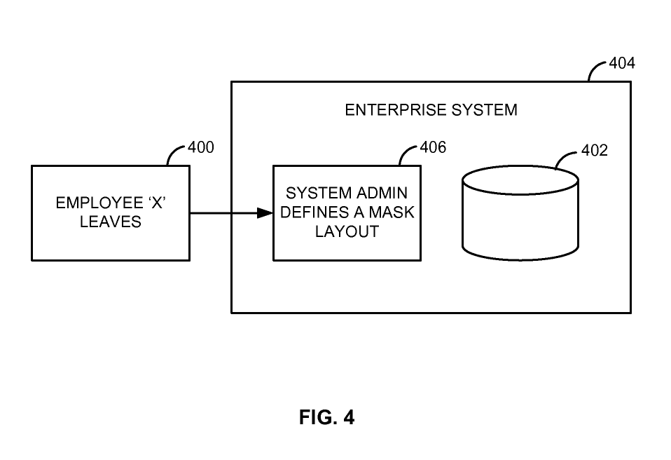

FIG. 4 illustrates an embodiment of a process for defining a mask layout in a business environment. When an entity such as an employee leaves 400 an organization, a system administrator is notified. Data of the employees is stored in an electronic database 402 of an enterprise system 404. In one embodiment, the enterprise system 404 is an on-premise system situated in one of the premises of the organization. The system administrator then defines a mask layout 406 for that employee in the enterprise system 404 by creating a table for defining the mask layout or by adding that employee in an existing table for defining the mask layout as described previously.

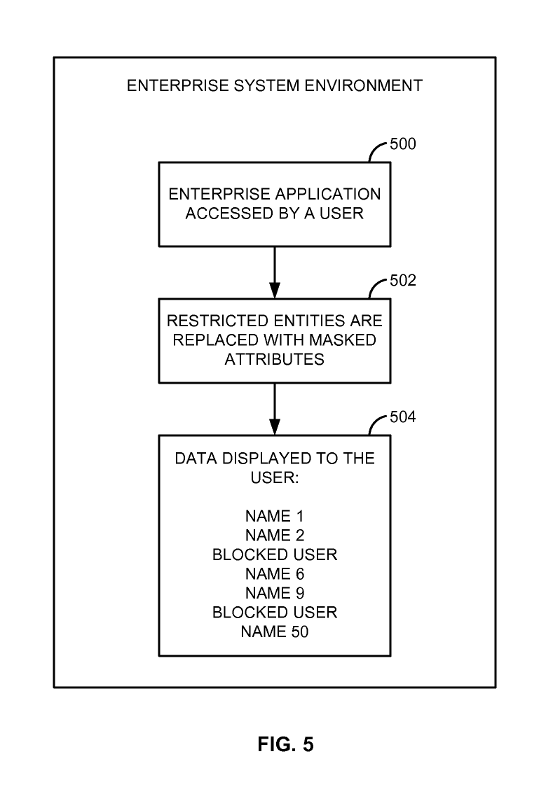

Referring to FIG. 5, several users of the organization use enterprise applications for various purposes. A user accesses an enterprise application 500 and selects various options to access data. A request for data is then created following user selections. If the requested data includes restricted entities for which a system administrator defined a masked layout, as described in reference to FIG. 4, then the restricted entities are replaced with masked attributes 502. Data is then displayed to the user. The displayed data includes unrestricted entities and masked attributes of the restricted entities. For unrestricted entities, attributes such as names (e.g., Name 1, Name 2, etc) and other dependant data are displayed. As described previously, masked attributes can include “Blocked User” or other characters that are defined by the system administrator in the mask layout.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

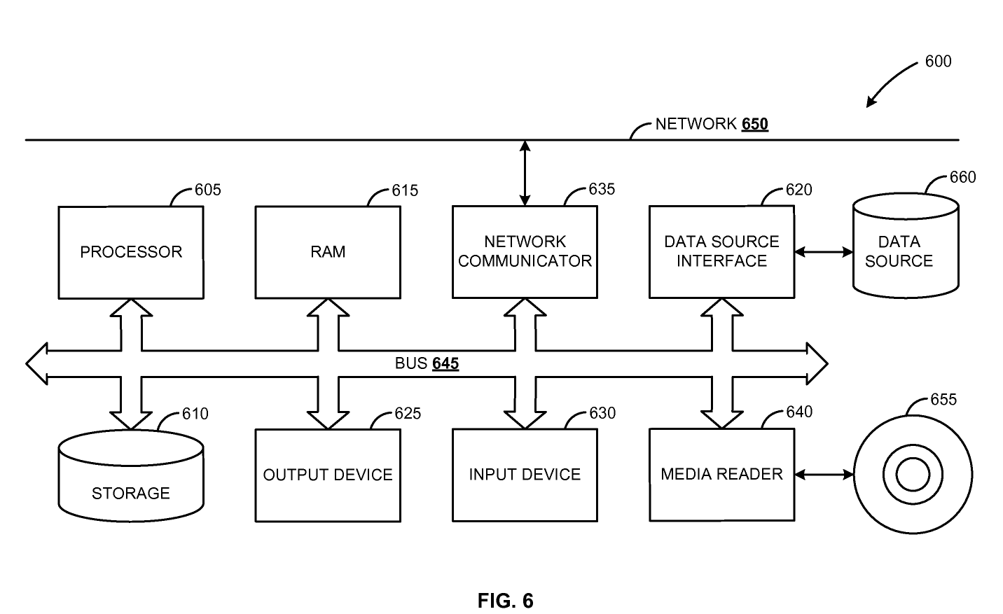

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

1. A computer implemented method for protecting data privacy, the method comprising:
a computer receiving a request to access data stored in an electronic database, wherein the data comprises restricted and unrestricted entities;
based on a mask layout, the computer replacing a restricted entity with one or more masked attributes that protect privacy of the restricted entity, wherein the mask layout comprises the one or more masked attributes defined for the restricted entity and a status indicating a blocking period for the restricted entity; and
the computer providing the one or more masked attributes to a user in response to the request.

2. The method of claim 1, further comprising:
providing one or more of the unrestricted entities along with the one or more masked attributes when the request corresponds to the restricted and unrestricted entities.

3. The method of claim 1, wherein the mask layout is defined based on a data privacy policy.

4. The method of claim 3, wherein the mask layout is defined for attributes of the restricted entity.

5. The method of claim 4, wherein the attributes of the restricted entity comprise a name and dependent data.

6. (canceled)

7. The method of claim 1, further comprising:
receiving the request in response to a user operation in an enterprise system.

8. An article of manufacture including a non-transitory computer readable storage medium to tangibly store instructions, which when executed by a computer, cause the computer to:
receive a request to access data stored in a database, wherein the data comprises restricted and unrestricted entities;
based on a mask layout, replace a restricted entity with one or more masked attributes that protect privacy of the restricted entity, wherein the mask layout comprises the one or more masked attributes defined for the restricted entity and a status indicating a blocking period for the restricted entity; and
provide the one or more masked attributes to a user in response to the request.

9. The article of manufacture of claim 8, further comprising instructions which when executed by the computer further causes the computer to:
provide one or more of the unrestricted entities along with the one or more masked attributes when the request corresponds to the restricted and unrestricted entities.

10. The article of manufacture of claim 8, wherein the mask layout is defined based on a data privacy policy.

11. The article of manufacture of claim 10, wherein the mask layout is defined for attributes of the restricted entity.

12. The article of manufacture of claim 11, wherein the attributes of the restricted entity comprise a name and dependent data.

13. (canceled)

14. The article of manufacture of claim 8, further comprising instructions which when executed by the computer further causes the computer to:
receive the request in response to a user operation in an enterprise system.

15. A computer system for protecting data privacy, comprising:
a computer memory to store program code; and
a processor to execute the program code to:
receive a request to access data stored in a database, wherein the data comprises restricted and unrestricted entities;
based on a mask layout, replace a restricted entity with one or more masked attributes that protect privacy of the restricted entity, wherein a mask layout comprises the one or more masked attributes defined for the restricted entity and a status indicating a blocking period for the restricted entity; and
provide the one or more masked attributes to a user in response to the request

16. The system of claim 15, wherein the processor further executes the program code to:
provide one or more of the unrestricted entities along with the one or more masked attributes when the request corresponds to the restricted and unrestricted entities

17. The system of claim 15, wherein the mask layout is defined based on a data privacy policy.

18. The system of claim 17, wherein the mask layout is defined for attributes of the restricted entity.

19. The system of claim 18, wherein the attributes of the restricted entity comprise a name and dependent data.

20. (canceled)
